(19) United States
(12) Patent Application Publication
(10) Pub. No.: US 2012/0248076 A1
(43) Pub. Date: Oct. 4, 2012

(54) LASER WELDING METHOD AND BATTERY MADE BY THE SAME

(75) Inventors: Hiroshi Hosokawa, Kasai-shi (JP); Haruhiko Yamamoto, Kasai-shi (JP)

(73) Assignee: SANYO Electric, Co., Ltd., Osaka (JP)

(21) Appl. No.: 13/402,434

(22) Filed: Feb. 22, 2012

(30) Foreign Application Priority Data
Mar. 31, 2011 (JP) 2011-080425

(51) Int. Cl. B23K 26/20

(52) U.S. Cl. 219/121.64; 219/121.63

(57) ABSTRACT

In a laser welding method including irradiating a welding portion between metallic members with a laser beam, the laser welding portion is covered with a cover made of a laser beam transmissive resin, and the metallic members are laser-welded together by irradiating the welding portion with the laser beam through the cover. The cover made of the laser beam transmissive resin may come in contact with the metallic members around the welding portion so that a gap is formed between the cover and the laser welding portion, thereby holding the gap in a hermetically closed state. It is therefore possible to provide a laser welding method between the metallic members for preventing metal particles that have spattered out of the welding portion from dispersing into surrounding areas.

### TECHNICAL FIELD

The present invention relates to a laser welding method between metallic members and to a battery made by the laser welding method, and particularly relates to a laser welding method between metallic members that prevents metal particles spattered out of a laser welding portion from dispersing into surrounding areas and to a battery made by the laser welding method.

### BACKGROUND ART

In the automotive industry, electric vehicles (EVs) and hybrid electric vehicles (HEVs) are actively developed as alternatives to motor vehicles that use fossil fuels such as gasoline, diesel oil, and natural gas. Nickel-hydrogen secondary batteries and lithium ion secondary batteries are used as batteries for such EVs and HEVs. In recent years, nonaqueous electrolyte secondary batteries such as lithium ion secondary batteries have become commonly used because they provide batteries with lightweight and high capacity.

In a battery for an EV or an HEV, a large current flows in the battery when it is discharged at a high output level. Therefore, the internal resistance of the battery needs to be reduced as much as possible. For that purpose, various improvements have been made to achieve low resistance at terminals. A mechanical crimping method has been commonly used as a method for achieving low resistance at terminals of these batteries. However, simply applying mechanical crimping changes the resistance with time under environments involving frequent vibrations such as in EVs and HEVs. Therefore, a laser welding method is used in combination, as shown, for example, in Japanese Patent Application Publications No. 2009-87693 and No. 2008-84755.

In the case of using the laser welding method in manufacturing processes of these batteries, metal particles that have spattered out of the welding portion may disperse during the laser welding if foreign material is attached to a laser welding portion, or if a clearance between metallic members in the laser welding portion is large. Although disturbances such as the adherence of foreign material to the welding portion are difficult to be completely suppressed, an electric short circuit may occur if metal particles that have spattered out due to the disturbances are attached in the vicinity of the welding portion. Therefore, in a manufacturing process of a battery, a step is required to inspect the state of attachment of the metal particles that have spattered out.

In Japanese Patent Application Publication No. 2009-285929, there is disclosed an invention of a method for manufacturing a hollow vessel by employing a laser welding method. As shown in FIG. 9, the method for manufacturing a hollow vessel 50 is provided in which recessed vessel bodies 54a, 54b are obtained by joining laser beam transmissive second resin bodies 53a, 53b to side faces of recessed metal bodies 51a, 51b and laser beam non-transmissive first resin bodies 52a, 52b shaped as recess-shaped bodies, and a laser beam is applied to abutting surfaces of the recessed vessel bodies 54a, 54b to weld them together, thus manufacturing the hollow vessel 50. The method includes a step in which the abutting surface of the first recessed vessel body 54a between the second resin bodies 53a, 53b is abutted to one abutting surface of an intermediate member 55 made of a laser beam non-transmissive resin, and a laser beam is applied to weld together the first recessed vessel body 54a and the one abutting surface of the intermediate member 55, and a step in which the abutting surface of the second recessed vessel body 54b between the second resin bodies 53a, 53b is abutted to the other abutting surface of the intermediate member 55, and a laser beam is applied to weld together the second recessed vessel body 54b and the other abutting surface of the intermediate member 55. However, such a laser welding method relates to a laser welding method between a transparent laser beam transmissive resin and a light-absorbing resin. Therefore, the method cannot be employed directly in laser welding between metallic members.

In Japanese Patent Application Publication No. 2006-286973, there is disclosed an invention of a method for manufacturing a capacitor element in which, as shown in FIG. 10, a capacitor 60 includes a capacitor element 61, an outer case 62 that has a mouth portion and contains the capacitor element 61, a sealing body 63 that hermetically seals the mouth portion of the outer case 62, and lead-out terminals 64 that are connected to the capacitor element 61 and led out of the sealing body 63 where the lead-out terminals 64 are bonded to the sealing body 63 in the hermetically sealed state. In the capacitor 60, the sealing body 63 is composed of a material that transmits a laser beam LB, and abutting portions of the lead-out terminals 64 and the sealing body 63 are hermetically sealed by irradiation of the laser beam LB. However, the method cannot be employed directly in laser welding between metallic members because this method for manufacturing a capacitor element relates to laser welding between a metallic member and a resin member.

### SUMMARY

In order to solve the problems in the laser welding methods of conventional techniques as described above, it is an object of the present invention to provide a laser welding method between metallic members that prevents metal particles spattered out of a laser welding portion from dispersing into surrounding areas during the laser welding between metallic members, and to provide a battery made by the laser welding method.

In order to achieve the above-described object, a laser welding method of the present invention includes irradiating a welding portion between metallic members with a laser beam. In the laser welding method, the laser welding portion is covered with a laser beam transmissive resin, and the metallic members are laser-welded together by irradiating the welding portion between the metallic members with the laser beam through the laser beam transmissive resin.

In the laser welding method of the present invention, the laser beam is applied through the laser beam transmissive resin to the welding portion between the metallic members. Accordingly, the metal particles do not disperse outside the resin because the metal particles that have spattered out of the welding portion during the laser welding are trapped inside the laser beam transmissive resin. Thus, it is possible to resolve the problem of an electric short circuit through the metal particles that have spattered out of the welding portion. Therefore, the laser welding method of the present invention is optimal for laser welding between metallic members constituting a battery, such as laser welding between electrode plate substrates of positive and negative electrodes and collectors of a battery, laser welding between collectors and terminals of a battery, and laser welding between a metallic outer can and a metallic sealing plate of a battery. Particularly, in cases where the welding portion is located inside a battery outer body, such as the case of welding between electrode plate substrates and collectors and the case of welding between collectors and terminals, it is important to prevent the spattered particles from dispersing in order to prevent the short circuit. Thus, it is more effective to apply the present invention to these welding portions.

It should be noted that, because heat generated at the laser welding portion is transmitted more to the welded metallic members that have high thermal conductivity than to the laser beam transmissive resin, the laser beam transmissive resin is not entirely melted or damaged by the heat. Thus, it is possible to prevent the metal particles that have spattered out of the welding portion from dispersing outside of the laser beam transmissive resin.

Various methods are available in order to fix the laser beam transmissive resin to the metallic members, such as using a pressing member or the like, and bonding the laser beam transmissive resin to the metallic members.

In the case of bonding the laser beam transmissive resin to the metallic members, it is allowable to keep the laser beam transmissive resin fixed by a holding device or the like during the laser welding, and, after finishing the laser welding, to bond the laser beam transmissive resin to the metallic members. However, it is preferable to bond in advance the laser beam transmissive resin to the metallic members before starting the laser welding. Various methods are available in order to bond the laser beam transmissive resin to the metallic members, such as heat-welding the laser beam transmissive resin to the metallic members, and using an adhesive agent. It is also possible use a laser to irradiate a portion of the metallic members that is in contact with the laser beam transmissive resin so as to generate heat at this potion and thereby to melt the laser beam transmissive resin, which is in turn bonded to the metallic members.

In the laser welding method of the present invention, it is preferable that the laser beam transmissive resin be made to contact the metallic members around the welding portion so that a gap is present between the laser beam transmissive resin and the laser welding portion, and the metallic members be laser-welded together in the state in which the gap is held in a hermetically closed state.

In the laser welding method of the present invention, the laser beam transmissive resin comes in contact with the metallic members around the welding portion so that a gap is present between the laser beam transmissive resin and the laser welding portion, and thereby holds the gap in a hermetically closed state. Therefore, the laser beam transmissive resin serves as a cover of the laser welding portion. As a result, the metal particles that have spattered out of the welding portion during the laser welding are trapped in the gap formed between the welding portion and the laser beam transmissive resin or inside the laser beam transmissive resin, and therefore, do not disperse into surrounding areas. In addition, because there is the gap formed between the welding portion and the laser beam transmissive resin, the risk that the metal particles that have spattered out of a surface of the metal in the welding portion immediately damage the transmissive resin is reduced. Therefore, it is less likely that the emitted laser beam does not correctly reach the welding portion on the metal surface, and it is less likely that the transmissive resin is damaged at a different level between each laser pulse. As a result, the welding portion is stabilized in quality.

Moreover, gas in the gap does not reach a temperature high enough to greatly expand because the heat generated at the laser welding portion is transmitted to the welded metallic members that have high thermal conductivity. Therefore, if the laser beam transmissive resin is fixed by the pressing member or bonded to the metallic members, the resin made of the laser beam transmissive resin serving as a cover of the laser welding portion does not come off, thus enabling performance of the laser welding in a satisfactory manner.

In the laser welding method of the present invention, it is also preferable that the laser beam transmissive resin be made to contact the metallic members around the laser welding portion via a laser beam non-transmissive resin.

The laser beam non-transmissive resin is heat-welded or bonded with an adhesive agent or the like to the metallic members; then, the laser beam transmissive resin is made to contact the laser beam non-transmissive resin; thereafter, the laser beam is applied through the laser beam transmissive resin to the laser beam non-transmissive resin so as to melt the laser beam non-transmissive resin; and thus, the laser beam transmissive resin can be bonded to the laser beam non-transmissive resin. In this case, the laser beam transmissive resin may be bonded to the laser beam non-transmissive resin either before or after the laser welding between the metallic members is performed. However, the bonding is preferably finished in advance before the laser welding between the metallic members is started.

Alternatively, it is also possible to follow the following procedure: The laser beam transmissive resin is bonded in advance to the laser beam non-transmissive resin; then, the welding portion is covered with the laser beam transmissive resin and the laser beam non-transmissive resin; thereafter, the laser beam is applied through the laser beam transmissive resin to the laser beam non-transmissive resin so as to melt the laser beam non-transmissive resin; and thus, the laser beam non-transmissive resin is bonded to the metallic members. Further alternatively, it is also possible to follow the following procedure: The welding portion is covered with the laser beam transmissive resin and the laser beam non-transmissive resin; then, the laser beam is applied through the laser beam transmissive resin to the laser beam non-transmissive resin so as to melt the laser beam non-transmissive resin; and thus, the bonding is effected simultaneously between the metallic members and the laser beam non-transmissive resin, and between the laser beam non-transmissive resin and the laser beam transmissive resin.

In the laser welding method of the present invention, it is also preferable that the laser beam transmissive resin be bonded so as to cover the laser welding portion by making the laser beam transmissive resin come in contact with the metallic members around the laser welding portion via the laser beam non-transmissive resin, and by melting the laser beam non-transmissive resin with reflected light from the laser welding portion.

A part of the laser beam applied to the welding portion between the metallic members is reflected. In the laser welding method of the present invention, the laser beam non-transmissive resin melts due to a rise in temperature because the laser beam non-transmissive resin interposed between the laser beam transmissive resin and the metallic members absorbs the reflected laser beam. Consequently, when the irradiation of the laser beam is finished, the laser beam non-transmissive resin is solidified and bonds the laser beam transmissive resin to the metallic members. As a result, the laser beam transmissive resin is firmly bonded to the metallic members around the welding portion. Therefore, with the laser welding method of the present invention, the laser welding portion is covered with the laser beam transmissive resin. Accordingly, it becomes further possible to suppress the short circuit caused by the metal particles that have spattered out during the laser welding.

Here, it is possible to bond in advance the laser beam non-transmissive resin to the metallic members before starting the laser welding between the metallic members, and then to perform the laser welding between the metallic members in the state in which the laser beam transmissive resin is in contact with the laser beam non-transmissive resin, thus using the reflected light by the laser welding to bond the laser beam transmissive resin to the laser beam non-transmissive resin. Alternatively, it is also possible to bond in advance the laser beam transmissive resin to the laser beam non-transmissive resin, then to cover the welding portion with the laser beam transmissive resin and the laser beam non-transmissive resin, and thereafter perform the laser welding between the metallic members, thus using the reflected light by the laser welding to bond the laser beam non-transmissive resin to the metallic members. Further alternatively, it is also possible to cover the welding portion with the laser beam transmissive resin and the laser beam non-transmissive resin, and then to use the reflected light during the laser welding between the metallic members to effect the simultaneous bonding between the metallic members and the laser beam non-transmissive resin, and between the laser beam non-transmissive resin and the laser beam transmissive resin.

Note that, if the laser beam non-transmissive resin is bonded in advance to the laser beam transmissive resin, the transmissivity for the laser beam can easily be maintained in a predetermined position during the laser welding.

In the laser welding method of the present invention, it is also preferable to form a projecting portion at the laser welding portion.

The laser beam non-transmissive resin easily melts by the laser beam because a reflection amount of the emitted laser beam increases when the projecting portion is formed at the laser welding portion. Therefore, the bonding can be effected more securely between the laser beam transmissive resin and the laser beam non-transmissive resin, or between the laser beam non-transmissive resin and the metallic members. Thus, the laser beam transmissive resin covers the laser welding portion more satisfactorily.

In the laser welding method of the present invention, it is also preferable to use a thermoplastic resin as the laser beam transmissive resin.

The thermoplastic resin absorbs heat when melting. Therefore, when it comes in contact with the metal particles that have spattered out during the laser welding, it draws heat from the metal particles and melts, thus cooling the metal particles. As a result, the metal particles can be trapped inside efficiently. Consequently, with the laser welding method of the present invention, the metal particles that have spattered out during the laser welding can be more satisfactorily suppressed from dispersing into surrounding areas.

In the laser welding method of the present invention, it is also preferable to use the laser beam transmissive resin mixed with a coloring agent as the laser beam non-transmissive resin.

If the laser beam transmissive resin mixed with a coloring agent is used as the laser beam non-transmissive resin, the bonding between each of the resins is stronger. Therefore, the laser welding portion can be covered more firmly.

In the laser welding method of the present invention, it is also preferable to fill the gap with an atmosphere gas suitable for laser welding.

The laser welding portion is likely to change in color or quality by reacting with ambient gas because it instantaneously reaches high-temperature. In the laser welding method of the present invention, the gap is filled with the atmosphere gas suitable for laser welding. Therefore, the laser welding portion hardly changes in color or quality, and thus, a laser welding portion with satisfactory quality is obtained. The atmosphere gas suitable for laser welding is commonly known as assist gas. Although low-cost nitrogen gas is normally used as the atmosphere gas, helium gas and argon gas can also be used depending on the application.

In the laser welding method of the present invention, it is also preferable that the metallic members can be metallic members constituting a battery, and in that case, the laser welding method of the present invention is applied to a case in which the metallic members constituting the battery are an electrode plate substrate and a collector, or a collector and a terminal of the battery.

Particularly, if the metallic members constituting a battery are an electrode plate substrate and a collector, or a collector and a terminal of the battery, the obtained battery can have a reduced internal resistance and can be prevented from developing an internal short circuit by employing the above-described laser welding method of the present invention as a laser welding method between the metallic members of the battery.

Moreover, in order to achieve the above-described object of the present invention, a battery of the present invention includes a laser welding portion between battery-constituting metallic members that is covered by a laser beam transmissive resin in the state in which a hermetically closed gap is included between the laser welding portion and the laser beam transmissive resin. Furthermore, in the battery of the present invention, it is preferable that a laser beam non-transmissive resin be interposed in a joint portion between the metallic members and the laser beam transmissive resin.

With the battery of the present invention, as described above in detail in the laser welding method of the present invention, the obtained battery can have a reduced internal resistance and can be prevented from developing an internal short circuit.

### BRIEF DESCRIPTION OF THE DRAWINGS

The invention will be described with reference to the accompanying drawings, wherein like numbers reference like elements.

FIG. 1 is a perspective view of a nonaqueous electrolyte secondary battery of an embodiment 1.

FIG. 2A is a front view showing an internal structure of the nonaqueous electrolyte secondary battery of the embodiment 1, and FIG. 2B is a cross-sectional view along a line IIB-IIB in FIG. 2A.

FIG. 3 is a perspective view before assembly of a negative terminal of the embodiment 1.

FIG. 4A is a partial cross-sectional view of the terminal of the embodiment 1 after being assembled and then welded by laser welding, and

FIG. 4B is a plan view of the same.

FIG. 5A is an enlarged view of a part VA in FIG. 4A, and FIG. 5B is a partial enlarged view of a variation.

FIG. 6A is a front view showing an internal structure of a nonaqueous electrolyte secondary battery of an embodiment 2, and FIG. 6B is a development view of a negative electrode collector.

FIG. 7A is an enlarged view of a slit portion in FIG. 6B; FIG. 7B is a cross-sectional view along a line VIIB-VIIB in FIG. 7A; and FIG. 7C is a cross-sectional view along a line VIIC-VIIC in FIG. 7A.

FIG. 8A is a cross-sectional view of a variation 1 at a location corresponding to FIG. 7B; FIG. 8B is a cross-sectional view of the same at a location corresponding to FIG. 7C; FIG. 8C is a cross-sectional view of a variation 2 at a location corresponding to FIG. 7B; and FIG. 8D is a cross-sectional view of the same at a location corresponding to FIG. 7C.

FIG. 9 is a cross-sectional view showing a conventional method for manufacturing a hollow vessel.

FIG. 10A is an exploded assembly cross-sectional view of a conventional capacitor, and FIG. 10B is a cross-sectional view showing a method for joining a lead-out terminal with a sealing body by using a laser beam.

### DESCRIPTION OF EXEMPLARY EMBODIMENTS

Embodiments of the present invention will be described below using the accompanying drawings. It should be noted that the embodiments shown below are for explanation purpose by using an example in which a laser welding method is applied to a prismatic nonaqueous electrolyte secondary battery in order to embody the technological concept of the present invention, but are not intended to limit the present invention to the prismatic nonaqueous electrolyte secondary battery. The present invention can be applied to other embodiments included in the scope of the claims.

### Embodiment 1

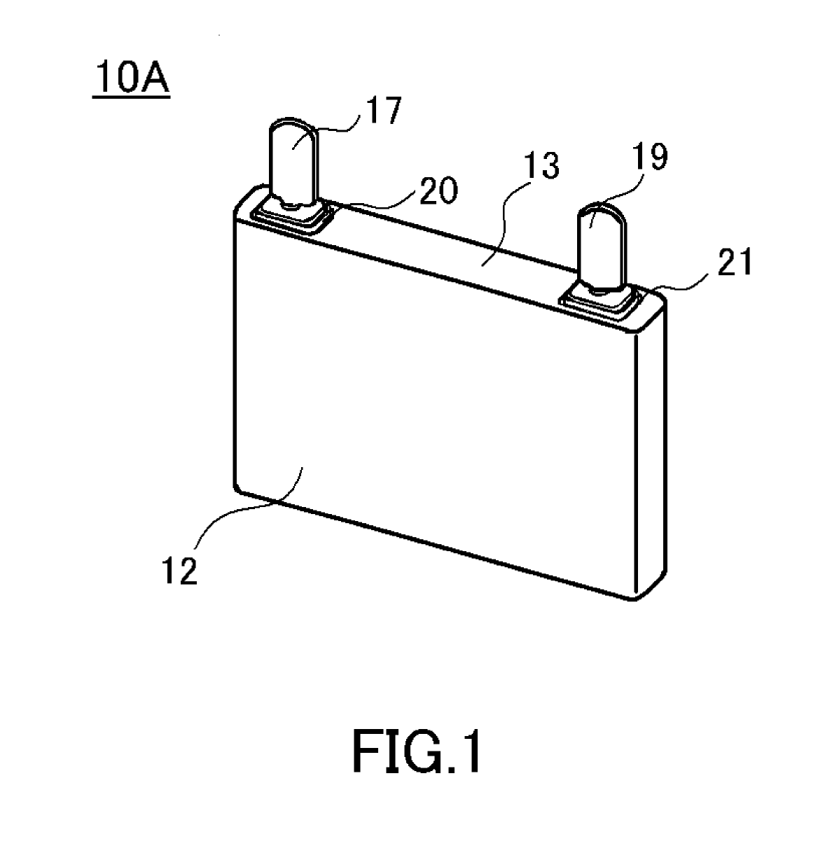

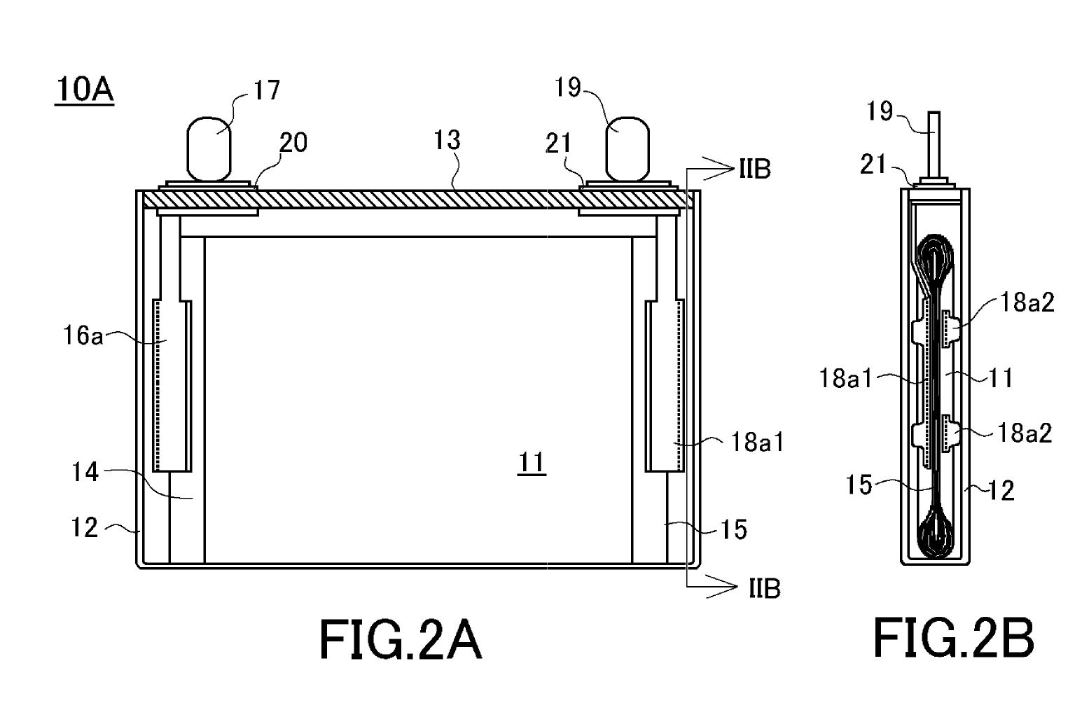

First, a prismatic nonaqueous electrolyte secondary battery of an embodiment 1 will be described using FIGS. 1 to 4B. The prismatic nonaqueous electrolyte secondary battery 10A is formed by housing in a prismatic battery outer can 12 a flat rolled electrode assembly 11 that is formed by rolling a positive electrode plate and a negative electrode plate with a separator (all of them not illustrated) interposed therebetween, and then by hermetically closing the battery outer can 12 with a sealing plate 13.

The positive electrode plate is produced by applying a positive electrode active material mixture onto both surfaces of a positive electrode substrate made of aluminum foil, and then by drying and thereafter rolling the substrate with the mixture so as to form a positive electrode substrate exposed portion 14 where the aluminum foil is exposed in a strip shape. The negative electrode plate is produced by applying a negative electrode active material mixture onto both surfaces of a negative electrode substrate made of copper foil, and then, by drying and thereafter rolling the substrate with the mixture so as to form a negative electrode substrate exposed portion 15 where the copper foil is exposed in a strip shape. The flat rolled electrode assembly 11 is produced by rolling the positive electrode plate and the negative electrode plate into a flat shape with a porous separator (not illustrated) made of polyethylene interposed therebetween so that the positive electrode substrate exposed portion 14 and the negative electrode substrate exposed portion 15 are located at both ends in the rolling axis direction.

The positive electrode substrate exposed portion 14 is connected to a positive terminal 17 via a positive electrode collector 16a, and the negative electrode substrate exposed portion 15 is connected to a negative terminal 19 via a negative electrode collector 18a1. The positive electrode collector 16a is welded by resistance welding to a positive electrode collector receiving member (not illustrated) with the positive electrode substrate exposed portion 14 interposed therebetween. In the same manner, the negative electrode collector 18a1 is welded by resistance welding to a negative electrode collector receiving member 18a2 with the negative electrode substrate exposed portion 15 interposed therebetween. The positive terminal 17 and the negative terminal 19 are fixed to the sealing plate 13 via insulating members 20 and 21, respectively. The prismatic nonaqueous electrolyte secondary battery 10A is produced by first inserting the flat rolled electrode assembly 11 into the prismatic battery outer can 12, then welding by laser welding the sealing plate 13 to a mouth portion of the battery outer can 12, and thereafter, by pouring a nonaqueous electrolyte from an electrolyte pour hole (not illustrated), and finally hermetically closing the electrolyte pour hole.

Here, description will be made of specific structures of the positive terminal 17 and the negative terminal 19 in the prismatic nonaqueous electrolyte secondary battery 10A of the embodiment 1. Although these two terminals differ from each other in that, normally, the positive electrode collector 16a is formed of aluminum-based metal whereas the negative electrode collector 18a1 is formed of copper-based metal, other structures are substantially the same. Therefore, the negative terminal 19 will be described as a typical one.

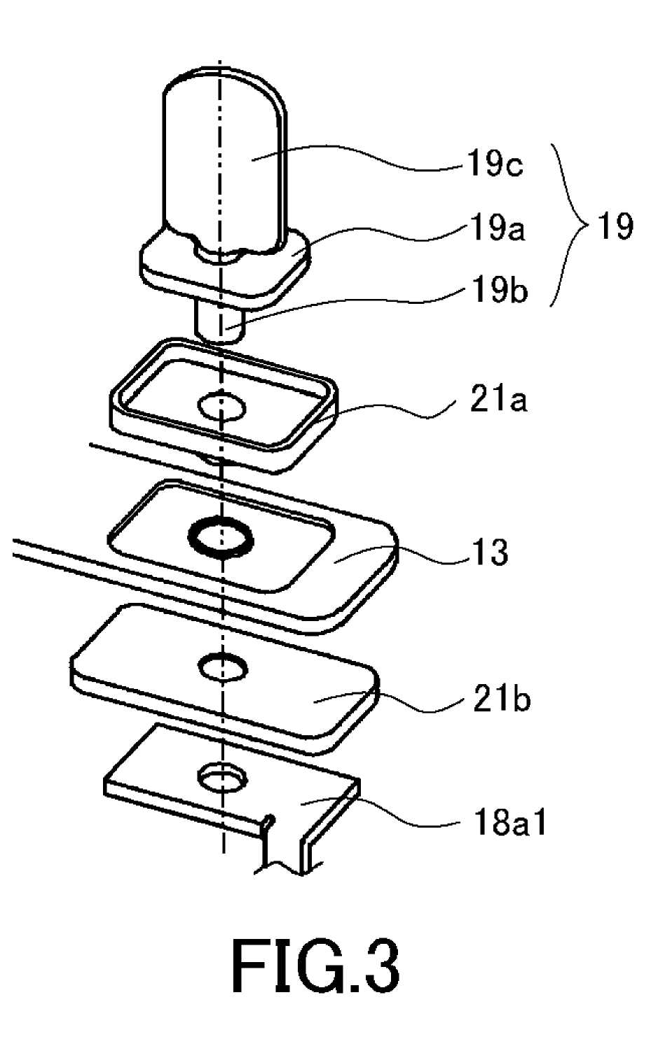

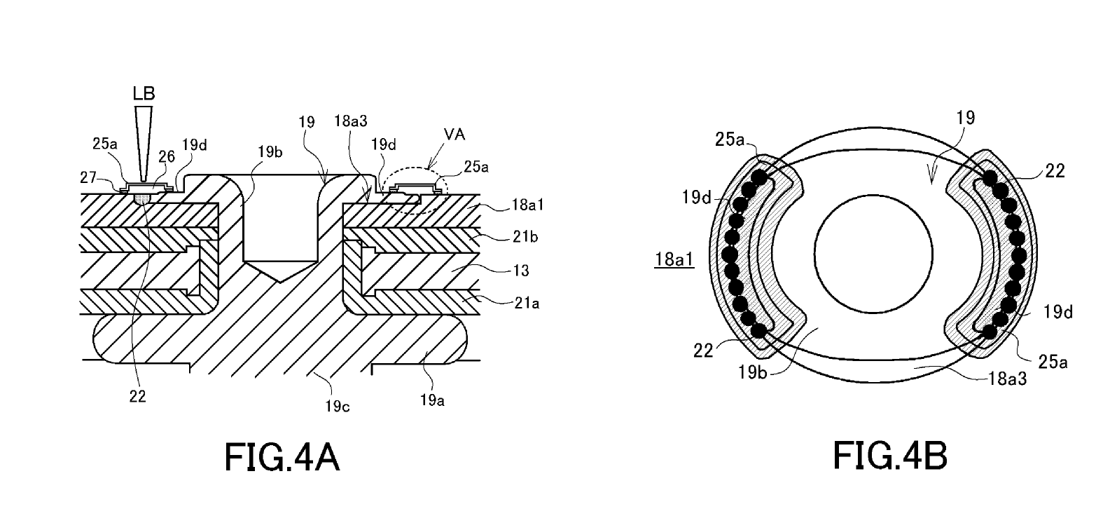

As shown in FIG. 3, the negative terminal 19 includes a cylindrical crimping member 19b provided on one side of a flange portion 19a, and a terminal portion 19c provided on the other side of the flange portion 19a. The cylindrical crimping member 19b is assembled by being inserted through openings respectively formed in a gasket 21a serving as a first insulator, the sealing plate 13, an insulating member 21b serving as a second insulator, and the negative electrode collector 18a1. As the negative electrode collector 18a1, a collector is used that is formed with a counterbore 18a3 around the opening through which the crimping member 19b of the negative terminal 19 is inserted, as shown in FIG. 4A.

In this assembled state, the negative terminal 19 is placed on a jig (not illustrated) so that the terminal portion 19c faces downward, and is crimped so that the crimping member 19b increases in diameter equally in all directions from a tip side thereof. The negative terminal 19 is also formed so that a thin-walled portion 19d having a smaller thickness than that of the other portion of the crimping member 19b is partially formed on the tip side of the crimping member 19b. Therefore, as shown in FIG. 4A, the thin-walled portion 19d at the end portion of the crimping member 19b adheres sufficiently firmly to the negative electrode collector 18a1 and becomes flat on a surface thereof. In addition, the thin-walled portion 19d at the end portion of the crimping member 19b is fitted in the counterbore 18a3 of the negative electrode collector 18a1.

In the negative terminal 19 of the embodiment 1, the flange portion 19a of the negative terminal 19, the gasket 21a, the sealing plate 13, the insulating member 21b, and the negative electrode collector 18a1 are mechanically fixed to each other. Therefore, the negative terminal 19 and the negative electrode collector 18a1 are mechanically firmly fixed to each other. In addition, because the thin-walled portion 19d at the end portion of the crimping member 19b is fitted in the counterbore 18a3 of the negative electrode collector 18a1, the negative terminal 19 and the negative electrode collector 18a1 further hardly move even if vibration is applied.

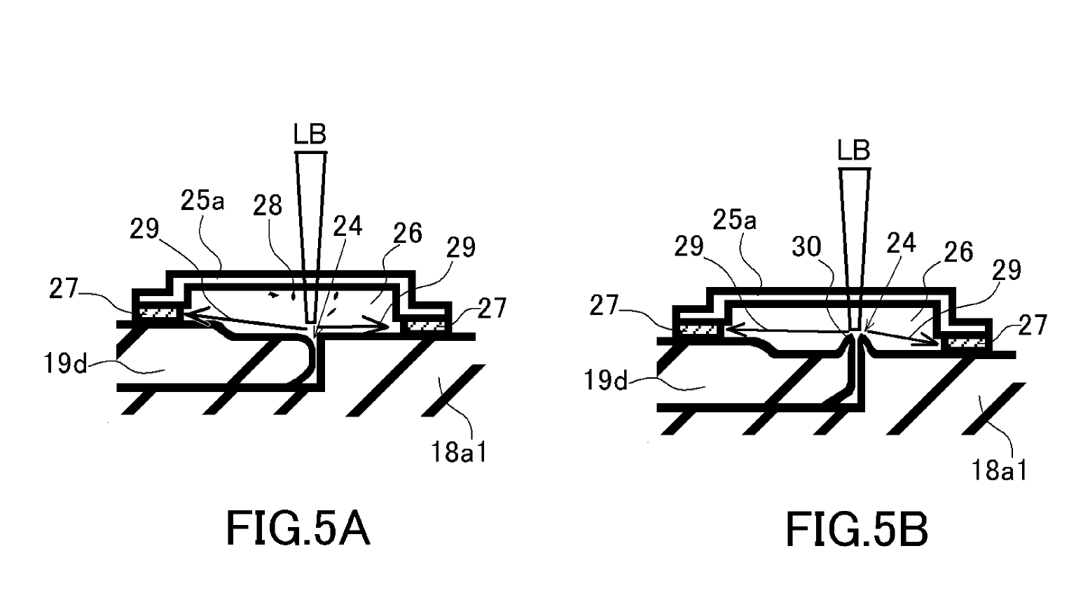

However, the electric resistance at the crimped portion can change with time under environments involving frequent vibrations such as in a battery for an EV or an HEV. Therefore, in the embodiment 1, it is preferable that, as shown in FIGS. 4A and 5A, a laser beam LB be applied to a portion where the thin-walled portion 19d at the end portion of the crimping member 19b is fitted in the counterbore 18a3 of the negative electrode collector 18a1 so that a surface of the thin-walled portion 19d at the end portion of the crimping member 19b and a surface of the negative electrode collector 18a1 are directly melted and welded to each other at spots. Note that reference numeral 22 in FIGS. 4A and 4B denotes a nugget formed by the laser welding, and that FIG. 5A is an enlarged view of a part VA in FIG. 4A.

In performance of the laser welding, for example, in order to obtain a depth of fusion of approximately 0.2 to 0.8 mm in a material having a thickness of approximately 0.2 to 2 mm in the laser welding of copper or aluminum, a high power density of approximately 5 to 20×10⁹ W/m² is required. Thus, spattered particles are likely to disperse when disturbances exist such as the adherence of foreign material to a welding portion. Reducing the power density of the laser beam makes spattered particles difficult to disperse. However, in the laser welding of copper or aluminum which has high thermal conductivity, a large amount of heat escapes into areas surrounding the welding portion. Thus, surrounding parts are affected by the heat, and also, a sufficient depth of fusion is not obtained.

Therefore, conditions are set under which a required depth of fusion is obtained at a relatively low power density at which spattering hardly occurs. However, because the heat affect is likely to occur at a relatively low power density, it is difficult to set the welding conditions, and there are cases in which no appropriate welding conditions are obtained. If spattering is inevitable in order to obtain a sufficient depth of fusion, it is required to provide, after the welding step, a step to inspect the attachment of dispersed material near the welding portion or a step to remove the dispersed material. However, providing such a step results in a reduction in manufacturing efficiency.

Therefore, in the embodiment 1, a vicinity of a laser welding portion 24 is covered with a cover 25a made of a thermoplastic resin, such as a polystyrene resin, that has a transmissivity for the laser beam, and the welding is performed by irradiating the welding portion with the laser beam LB through the cover 25a. The cover 25a covers the entire circumference of the laser welding portion 24 so as to form a gap 26 between itself and the negative electrode collector 18a1 and the thin-walled portion 19d at the end portion of the crimping member 19b which are metallic members. Here, the cover 25a is preferable to have a thickness of approximately 0.05 to 1 mm.

A laser beam non-transmissive resin portion 27 made of, for example, a polystyrene resin mixed with acetylene black serving as a coloring agent is integrally fixed to a portion where the cover 25a is bonded on the negative electrode collector 18a1 and the thin-walled portion 19d at the end portion of the crimping member 19b which are metallic members. The laser beam non-transmissive resin portion 27 is fixed, for example, by heat welding, to the negative electrode collector 18a1 and the thin-walled portion 19d at the end portion of the crimping member 19b. The laser beam non-transmissive resin portion 27 may have any thickness, but preferably the same as or smaller than the thickness of the cover 25a.

Here, the cover 25a is pressed at a force of 10 to 200 N so as to hermetically seal the vicinity of the laser welding portion 24 so that the gap 26 formed between the negative electrode collector 18a1 and the thin-walled portion 19d at the end portion of the crimping member 19b which are metallic members is hermetically sealed. Therefore, even if metal particles 28 that have spattered out of the laser welding portion 24 disperse, the metal particles 28 are captured in the resin forming the cover 25a, and thus do not disperse outside the cover 25a. If a thermoplastic resin is used for forming the cover 25a, the thermoplastic resin draws heat from the metal particles 28 and melts when it comes in contact with the metal particles 28 that have spattered out during the laser welding. Therefore, the metal particles 28 are cooled, and thereby, trapped inside the cover 25a. Thus, the metal particles that have spattered out during the laser welding can be more satisfactorily suppressed from dispersing into surrounding areas.

During the laser welding, a part of the laser beam is reflected and spreads peripherally from the laser welding portion 24, as shown in FIG. 5A. When this reflected light 29 is absorbed by the laser beam non-transmissive resin portion 27, the laser beam non-transmissive resin portion 27 rises in temperature and melts. Consequently, the cover 25a is firmly fixed via the laser beam non-transmissive resin portion 27 to the negative electrode collector 18a1 and the thin-walled portion 19d at the end portion of the crimping member 19b which are metallic members. Therefore, the laser welding portion 24 is held in the state of being covered with the cover 25a even after the external force is removed after the laser welding.

Even if the laser beam non-transmissive resin portion 27 that is in contact with the laser beam transmissive resin forming the cover 25a is not fixed to the metallic members, it is possible to firmly fix the cover 25a to the negative electrode collector 18a1 and the thin-walled portion 19d at the end portion of the crimping member 19b by melting the laser beam non-transmissive resin portion 27 with the reflected light during the laser welding. It should be noted that, when the laser welding portion 24 is provided with a projecting portion 30 as shown in FIG. 5B, the emitted laser beam is more likely to be reflected peripherally by virtue of the projecting portion 30, and thus, the laser beam non-transmissive resin portion 27 can be melted more satisfactorily. The projecting portion 30 is preferable to have a height of approximately 0.1 to 0.5 mm.

In order to obtain a satisfactory welding state, it is preferable to create a processing atmosphere suitable for laser welding. If the laser welding portion 24 is covered with an atmosphere gas suitable for laser welding by filling the gap 26 with the atmosphere gas suitable for laser welding, the atmosphere gas need not be always blown during the laser welding. Thus, the amount of the atmosphere gas used can be suppressed. It is only necessary to appropriately select and use an inert gas as the atmosphere gas, such as helium gas, argon gas, or nitrogen gas, that is commonly known as an assist gas for laser welding.

As described above, in the laser welding method in the embodiment 1, the cover 25a formed of the laser beam transmissive resin forms the gap 26 between itself and the laser welding portion 24, and holds the gap 26 in the hermetically closed state by being in contact, around the laser welding portion 24, with the negative electrode collector 18a1 and the thin-walled portion 19d at the end portion of the crimping member 19b which are metallic members. As a result, the metal particles 28 that have spattered out of the laser welding portion 24 during the laser welding are trapped in the gap 26 formed between the laser welding portion 24 and the cover 25a or inside the laser beam transmissive resin forming the cover 25a, and therefore, do not disperse into surrounding areas.

In addition, because there is the gap 26 formed between the laser welding portion 24 and the cover 25a, the risk that the metal particles 28 that have spattered out of the surface of the metal in the laser welding portion 24 immediately damage the laser beam transmissive resin forming the cover 25a is reduced. Therefore, it is less likely that the emitted laser beam does not correctly reach the welding portion 24 on the metal surface. It is also less likely that the cover 25a formed of the laser beam transmissive resin is damaged to a different level between each laser pulse. As a result, the quality of the welding portion 24 by the laser welding is stabilized.

Moreover, because the heat generated at the laser welding portion 24 is transmitted to the negative electrode collector 18a1 and the thin-walled portion 19d at the end portion of the crimping member 19b which are highly thermally conductive metallic members to be welded, the gas in the gap 26 does not reach a temperature high enough to expand greatly. Therefore, if the cover 25a is fixed by a pressing member (not illustrated), the cover 25a of the laser welding portion does not come off, thus enabling satisfactory performance of the laser welding.

According to the embodiment 1, an electric short circuit does not occur due to dispersed material because the laser welding is performed in the state in which the laser welding portion is covered with the laser beam transmissive resin and is hermetically sealed. Consequently, it is not necessary to inspect the state of attachment of spattered particles after the laser welding, and welding conditions can also be used under which spattering is likely to occur.

Although the above-described embodiment 1 has shown the example in which the gap 26 is formed between the laser welding portion 24 and the cover 25a, the gap 26 is not necessarily required. That is, if the laser welding portion 24 is directly covered with the laser beam transmissive resin so that no gap is present, the metal particles that have spattered out of the surface of the metal in the welding portion 24 are trapped inside the laser beam transmissive resin when a welding operation is performed once. Then, when a laser beam is applied again to the same place, the laser beam may not be correctly applied to the laser welding portion because the laser beam is diffusely reflected by the metal particles.

However, in the embodiment 1 described above, because the laser welding is performed while shifting the welding portion to multiple places, the laser welding after shifting the welding portion is performed at a place where the laser beam transmissive resin is not damaged. Therefore, the laser beam transmissive resin that has been damaged at a previous laser welding portion has little influence on the next laser welding operation. If the gap 26 need not be formed between the laser welding portion 24 and the cover 25a, the laser beam transmissive resin made of a thermoplastic resin can be easily fixed by being heated to be melted, and thereafter, by being arranged at the predetermined laser welding portion 24.

### Embodiment 2

An embodiment 2 is obtained by applying the present invention to a prismatic nonaqueous electrolyte secondary battery 10B serving as a prismatic sealed battery disclosed in Japanese Patent Application Publication No. 2008-84755 mentioned above. As the prismatic nonaqueous electrolyte secondary battery 10B of the embodiment 2 differs from the prismatic nonaqueous electrolyte secondary battery 10A of the embodiment 1 only in the structures of a positive electrode collector 16b and a negative electrode collector 18b1, the same reference numerals are given to respective parts having the same structure, and detailed descriptions thereof will be omitted. As for the positive electrode collector 16b and the negative electrode collector 18b1 of the embodiment 2, the positive electrode collector 16b is formed of aluminum whereas the negative electrode collector 18b1 is formed of copper, and each of the collectors has a symmetrical shape. Therefore, the negative electrode collector 18b1 will be described as a typical one.

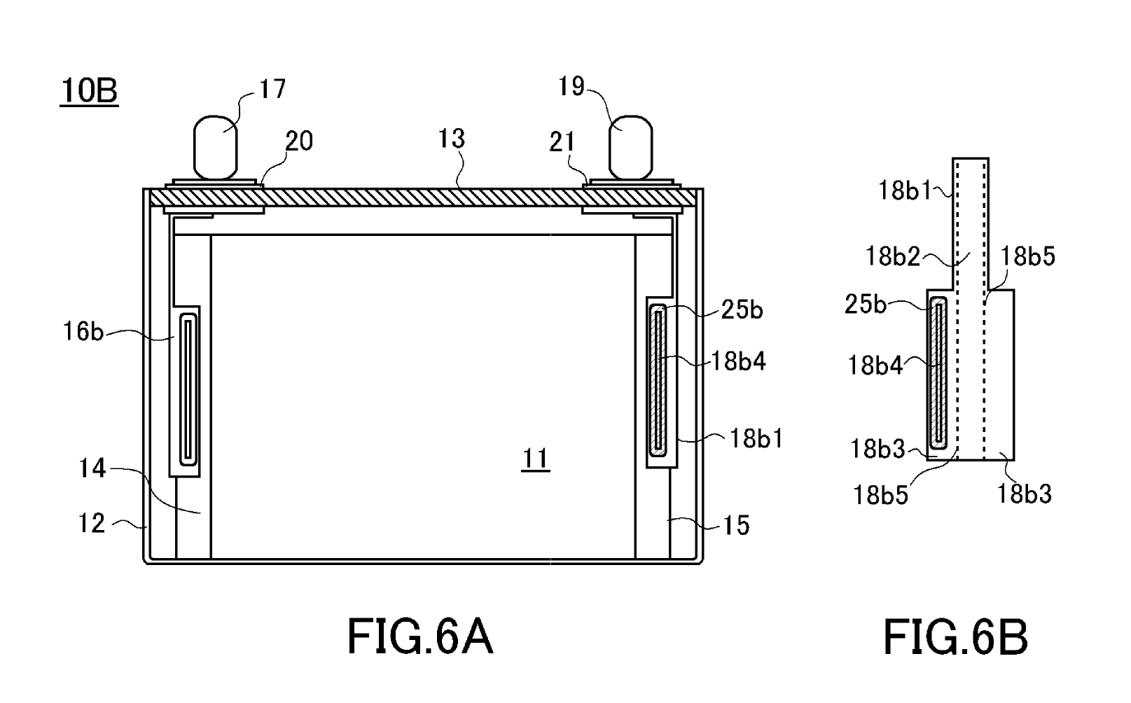

As shown in FIG. 6B, the negative electrode collector 18b1 has a shape including a rectangular main body portion 18b2 and a pair of expanded portions 18b3 at both sides of a lower side of the main body portion, when viewed in a developed state. At one side of the pair of expanded portions 18b3, a slit 18b4 is formed in parallel with the longitudinal direction of the negative electrode collector 18b1. In order to mount the negative electrode collector 18b1 to the negative electrode substrate exposed portion 15, the negative electrode substrate exposed portion 15 is compressed and integrated in advance, for example, by ultrasonic welding; then, the pair of expanded portions 18b3 of the negative electrode collector 18b1 are bent along bending parts 18b5; and finally, the integrated negative electrode substrate exposed portion 15 is interposed between the pair of expanded portions 18b3 thus bent.

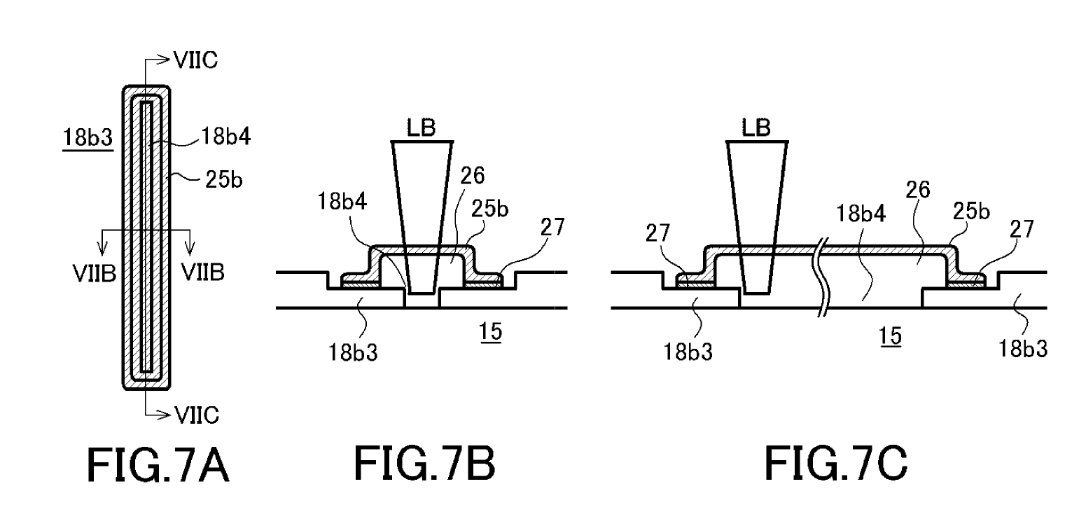

Thereafter, as shown in FIGS. 7A to 7C, the slit 18b4 is covered with a cover 25b made of the laser beam transmissive resin so as to form the gap 26. In addition, the laser beam non-transmissive resin portion 27 is arranged between the cover 25b and the negative electrode collector 18b1, and the cover 25b is held in a predetermined welding position by an appropriate holding device.

Then, as shown in FIGS. 7B and 7A, laser welding is performed by applying a laser beam into the slit 18b4 through the cover 25b and the gap 26, and simultaneously melting the expanded portion 18b3 of the negative electrode collector 18b1 and the negative electrode substrate exposed portion 15. This laser welding is performed by moving the laser beam LB along the slit 18b4. That is, in the embodiment 2, the portion of the slit 18b4 corresponds to the welding portion 24 (refer to FIGS. 5A and 5B) in the embodiment 1. Consequently, the expanded portion 18b3 of the negative electrode collector 18b1 and the negative electrode substrate exposed portion 15 are firmly welded together along the slit 18b4, and thus, metal particles that have spattered out during this laser welding do not disperse outside the cover 25b.

It should be noted that, in this laser welding, it is desired to control the intensity and irradiation time of the laser beam LB so that a nugget (not illustrated) formed by the laser welding penetrates the bundled negative electrode substrate exposed portion 15 and melt also the expanded portion 18b3 of the negative electrode collector 18b1 that is located on the opposite side of the laser beam irradiation side. Also in this case, the laser beam non-transmissive resin portion 27 can be melted by a laser beam reflected from the laser irradiation position. However, in the embodiment 2, a sufficient amount of reflected light may not be obtained because the laser irradiation position has a large area. Therefore, it is allowable to apply the laser beam LB separately through the cover 25b so as to directly melt the laser beam non-transmissive resin portion 27, or to bond the laser beam non-transmissive resin portion 27 to be fixed to an appropriate location by heating and melting the laser beam non-transmissive resin portion 27.

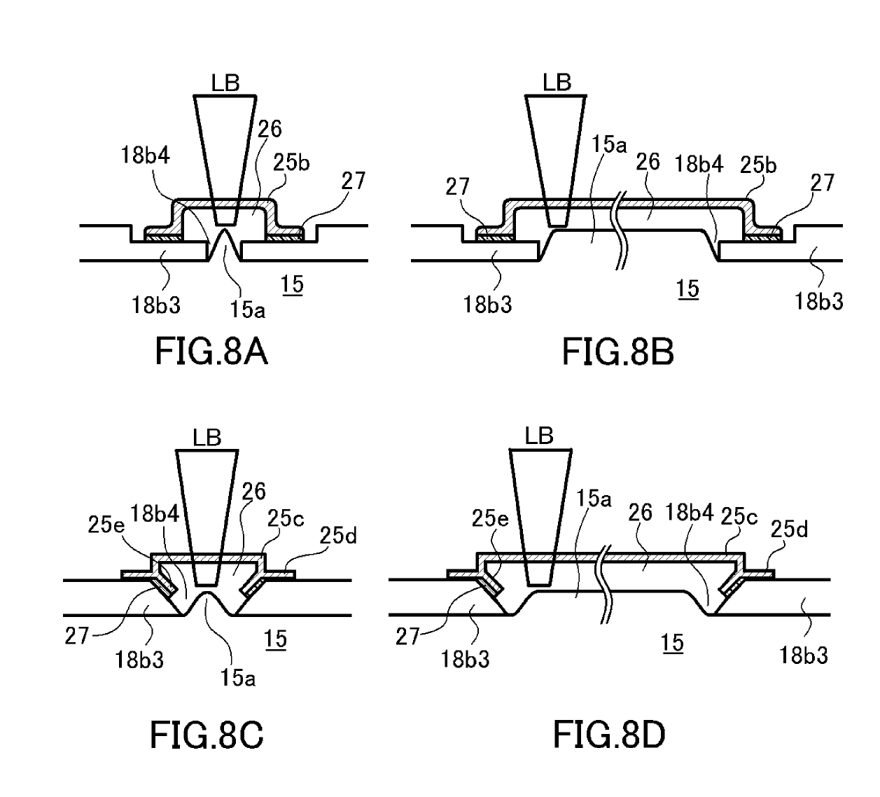

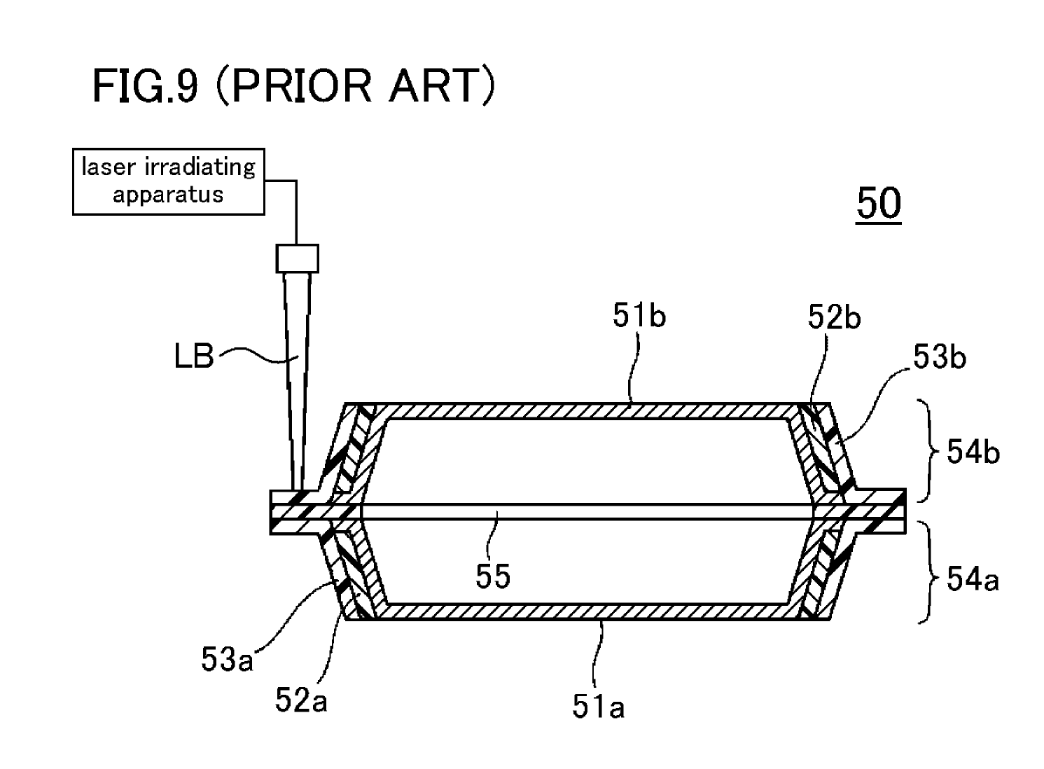

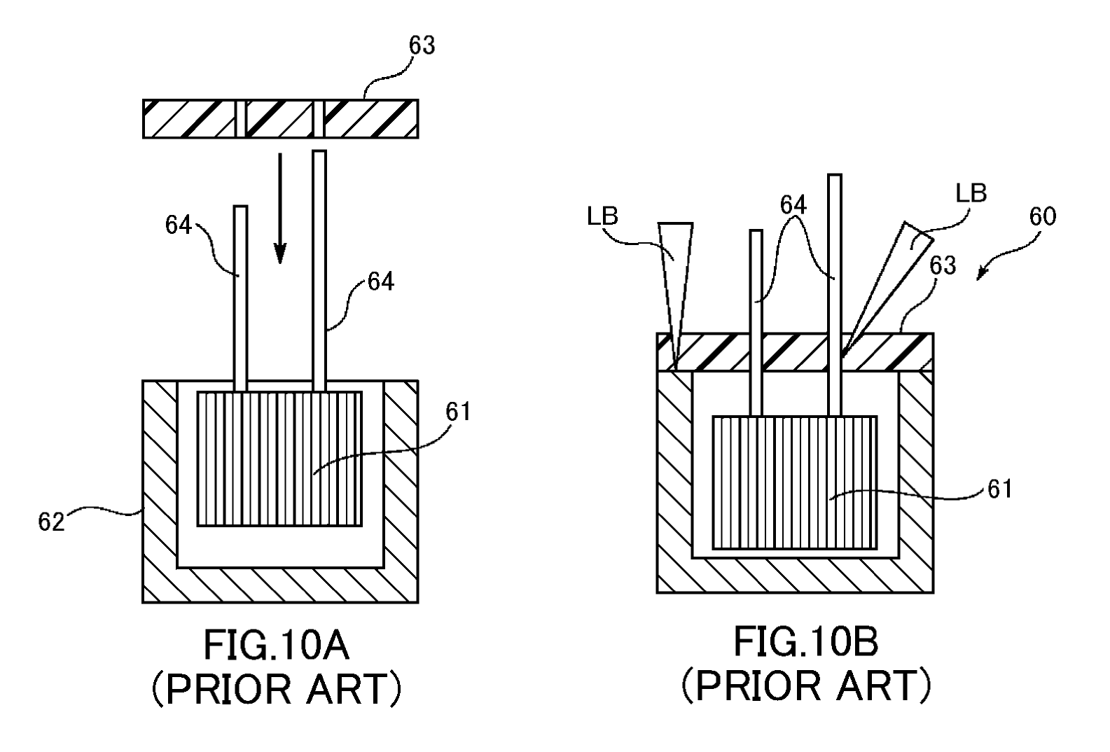

The negative electrode substrate exposed portion 15 is easily deformed because it is formed by bundling thin copper foils. Therefore, when the pair of expanded portions 18b3 of the negative electrode collector 18b1 are strongly pressed on a surface of the negative electrode substrate exposed portion 15, the surface of the negative electrode substrate exposed portion 15 bulges into the slit 18b4 and forms a projection 15a as shown in FIGS. 8A and 8B as a variation 1. The projection 15a corresponds to the projecting portion 30 (refer to FIG. 5B) formed at the laser welding portion 24 of the embodiment 1. Forming the projection 15a as described above increases the amount of the laser beam LB reflected by the projecting portion. Therefore, the laser beam non-transmissive resin portion 27 can be melted effectively, and the cover 25b can be fixed to the surface of the expanded portion 18b3 of the negative electrode collector 18b1 after the laser welding is finished. In order to provide the projection 15a on the negative electrode substrate exposed portion 15, a method may be used in which a projection is provided on the expanded portion 18b3 of the negative electrode collector 18b1 that faces the slit 18b4 via the negative electrode substrate exposed portion 15 so that the negative electrode substrate exposed portion 15 bulges into the slit 18b4.

In the embodiment 2 and variation 1, examples have been shown in which no device is provided for separately holding the cover 25a or 25b at the predetermined welding position. However, a cover 25c may be provided with a pressing portion 25d and a joint portion 25e as shown in FIGS. 8C and 8D as a variation 2. That is, in the variation 2 shown in FIGS. 8C and 8D, the cover 25c is provided with the pressing portion 25d that is located on the expanded portion 18b3 of the negative electrode collector 18b1 and serves solely for pressing the expanded portion 18b3 toward the predetermined welding position during the laser welding, and provided with the joint portion 25e that is arranged along an inner wall of the slit 18b4 formed in the expanded portion 18b3 of the negative electrode collector 18b1, the pressing portion 25d and the joint portion 25e being provided with the laser beam non-transmissive resin portion 27 on the side of the expanded portion 18b3 of the negative electrode collector 18b1.

By employing the cover 25c having such a structure, the joint portion 25e is held in a state of being stably fitted on the inner wall of the slit 18b4, and the cover 25c is stably pressed by the pressing portion 25d onto the expanded portion 18b3 of the negative electrode collector 18b1. Therefore, the cover 25c is held over the slit 18b4 in a stable state, and thus, the laser welding portion is stabilized in quality. In addition, because the joint portion 25e of the cover 25c is located on the inner wall side of the slit 18b4, the reflected light reflected from the laser welding portion easily reaches the joint portion 25e and the laser beam non-transmissive resin portion 27, and thus, the bonding strength between the cover 25c and the expanded portion 18b3 of the negative electrode collector 18b1 increases.

Note that, also in the cases of the embodiment 2 and the variations 1 and 2, it is not an essential structural requirement to provide the gap 26. However, the laser beam LB needs to have a high intensity and a long irradiation time due to the necessity of forming the nugget so as to penetrate the bundled negative electrode substrate exposed portion 15. Therefore, a large number of metal particles can spatter out. For that reason, also in the cases of the embodiment 2 and the variations 1 and 2, the gap 26 is preferable to be formed.

A laser welding apparatus usable in the present invention is not limited to a pulse type laser welding apparatus, but may be a continuous oscillation type laser welding apparatus. Although the laser beam transmissive resin usable in the present invention is not particularly limited, it is possible to use, for example, polystyrene, low-density polyethylene, and polycarbonate.

In the above-described embodiments, examples have been shown in which the laser beam non-transmissive resin portion is used. Instead of using the laser beam non-transmissive resin portion 27, a configuration may be employed in which the laser beam transmissive resin is directly fixed or bonded to the metallic members.

What is claimed is:

1. A laser welding method comprising:
covering a laser welding portion between metallic members with a laser beam transmissive resin, and
laser-welding the metallic members together by irradiating the welding portion between the metallic members with the laser beam through the laser beam transmissive resin.

2. The laser welding method according to claim 1, wherein the laser beam transmissive resin is made in contact with the metallic members around the welding portion so that a gap is present between the laser beam transmissive resin and the laser welding portion, and the metallic members are laser-welded together in a state in which the gap is held in a hermetically closed state.

3. The laser welding method according to claim 1, wherein the laser beam transmissive resin is made in contact with the metallic members around the laser welding portion via a laser beam non-transmissive resin.

4. The laser welding method according to claim 3, wherein the laser beam transmissive resin is bonded so as to cover the laser welding portion by melting the laser beam non-transmissive resin with reflected light from the laser welding portion.

5. The laser welding method according to claim 4, wherein a projecting portion is formed at the laser welding portion.

6. The laser welding method according to claim 1, wherein a thermoplastic resin is used as the laser beam transmissive resin.

7. The laser welding method according to claim 3, wherein a thermoplastic resin mixed with a coloring agent is used as the laser beam non-transmissive resin.

8. The laser welding method according to claim 2, wherein the gap is filled with an atmosphere gas suitable for laser welding.

9. The laser welding method according to claim 1, wherein the metallic members are metallic members constituting a battery.

10. The laser welding method according to claim 9, wherein the metallic members constituting the battery are an electrode plate substrate and a collector, or a collector and a terminal of the battery.

11. A battery comprising:
metallic members; and
a laser welding portion between the metallic members,
the laser welding portion being covered by a laser beam transmissive resin in a state in which a hermetically closed gap is formed between the laser welding portion and the laser beam transmissive resin.

12. The battery according to claim 11, wherein a laser beam non-transmissive resin is interposed in a joint portion between the metallic members and the laser beam transmissive resin.
